(19) United States
(12) Patent Application Publication
(10) Pub. No.: US 2009/0251522 A1
(43) Pub. Date: Oct. 8, 2009

(54) TARGET TRANSPORT DEVICE AND RECORDING APPARATUS

(75) Inventor: Yoshikazu KOIKE, Chino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/416,213

(22) Filed: Apr. 1, 2009

(30) Foreign Application Priority Data
Apr. 2, 2008 (JP) 2008-096211

(51) Int. Cl. B41J 2/01

(52) U.S. Cl. 347/104

(57) ABSTRACT

There is provided a target transport device including a support member having a support surface capable of supporting a target that is transported toward a downstream side from an upstream side, suction openings of suction holes capable of generating a negative pressure when the suction holes are suctioned being formed on the support surface, a heater for heating the support member, and a temperature adjusting unit for adjusting a temperature of the target such that a temperature difference generated in the target due to uneven distribution of the suction openings that relatively become a low temperature in the support member when heat from the heater is applied to the target via the support surface of the support member is restrained.

### BACKGROUND

1. Technical Field

The present invention relates to a recording apparatus such as, for example, an ink jet type printer, and to a target transport device equipped in the recording apparatus.

2. Related Art

An ink jet type recording apparatus (hereinafter, referred to as “printer”) for printing a character or an image on a target by ejecting ink from a recording head has been conventionally widely known as a recording apparatus (for example, JP-A-2006-150723 (hereinafter, referred to as Patent Document 1)). A platen (support member) for supporting a target and a recording head (recording means) for ejecting ink to the target supported by the platen are provided in the printer described in Patent Document 1. When a target is transported on the platen from an upstream side than the platen, ink is to be ejected to the target on the platen from the recording head in the state where the transport of the target is temporally stopped.

A plurality of suction holes are formed on an upper surface of the platen over the entire area of the target in the width direction. The target is absorbed on the platen by suctioning the inside of the suction holes by a fan (suction means). As a result, flatness of the target is surely kept on the platen, and the ink ejected from the recording head is preferably adhered on the target.

A plurality of heating means extending in the width direction of the target are disposed on a lower surface of the platen so as to make contact with the platen, and heat from the heating means is transmitted to the target on the platen via the platen. This makes it possible to promptly dry the ink adhered on the target.

Incidentally, in the printer described in Patent Document 1, suction openings each having a circular shape of the suction holes are arranged in a square reticular pattern on the upper surface of the platen, and a plurality of suction opening rows each of which is formed by the plurality of suction openings formed along a transport direction are formed with a predetermined interval in a width direction. Accordingly, when the target is passed through the upper surface of the platen, a specific area of the target repeatedly passes through on the suction openings of each suction opening row, whereas an area sandwiched by the specific areas in the width direction do not pass through on the suction openings at all. Accordingly, a streaky high temperature portion and a low temperature portion generate in the target along the transport direction to cause temperature unevenness in a recording area of the target. As a result, there is a problem in that dispersion occurs in the drying level of the ink ejected in the recording area of the target to deteriorate print quality.

### SUMMARY

An advantage of some aspects of the invention is to provide a target transport device and a recording apparatus which make it possible to restrain occurrence of drying unevenness of a target after a recording processing is performed by adherence of liquid while absorbing the target for assuring flatness of the target in a transport process of the target.

According to a first aspect of the invention, there is provided a target transport device including a support member having a support surface capable of supporting a target that is transported toward a downstream side from an upstream side, suction openings of suction holes capable of generating a negative pressure when the suction holes are suctioned being formed on the support surface, a heater for heating the support member, and a temperature adjusting unit for adjusting a temperature of the target such that a temperature difference generated in the target due to uneven distribution of the suction openings that relatively become a low temperature in the support member when heat from the heater is applied to the target via the support surface of the support member is restrained.

In general, when suction openings of suction holes are formed on a support surface of a support member, since the suction openings of the suction holes are formed on the support surface of the support ember, a temperature difference is generated between an area in which the suction openings are formed on the support surface and an area in which the suction openings are not formed on the support surface when the support member is heated by a heater. Accordingly, when the heat from the heater is applied to the target via the support surface of the support member, a temperature difference is generated in the target. In this regard, according to the structure, since the temperature difference generated in the garget is restrained by the temperature adjusting unit in this manner, occurrence of drying unevenness of the target can be restrained while absorbing the target to assure flatness thereof in a transport process of the target.

It is preferable that the temperature adjusting unit adjusts the temperature of the target in a step before the target is transported on the support surface of the support member in the target transport device according to the first aspect of the invention.

According to the structure, the temperature of the target is adjusted by the temperature adjusting unit in a step before the target is transported on the support surface such that a temperature difference of the target generated on the support surface of the support member is restrained. Accordingly, since the temperature difference generated in the target is restrained on the support surface, occurrence of drying unevenness of the target on the support surface can be restrained.

It is also preferable that the temperature adjusting unit adjusts the temperature of the target such that a temperature of an area of the target corresponding to a low occupation area on the support surface in which an occupation ratio of the suction openings is relatively low becomes lower than a temperature of an area of the target corresponding to a high occupation area on the support surface in which the occupation ratio of the suction openings is relatively high in the target transport device according to the first aspect of the invention.

In general, in the process that the target is transported on the support surface, a contact time of the area of the target that passes through the low occupation area becomes longer than that of the area of the target that passes through the high occupation area. That is, since a heat amount received from the support surface in the area of the target that passes through the low occupation area becomes larger than a heat amount received from the support surface in the area of the target that passes through the high occupation area, a temperature difference is generated on the support surface. In this regard, according to the structure, since the temperature adjusting unit adjusts the temperature of the target such that the temperature of the area of the target corresponding to the low occupation area becomes lower than the temperature of the area of the target corresponding to the high occupation area, the temperature difference of the target generated on the support surface can be surely restrained.

It is also preferable that the target transport device according the first aspect of the invention further includes a transport body for placing the target, the transport body being interposed between the target and the support member and being equipped with communication portions capable of communicating with the suction openings, and that the target is absorbed on the transport body by a suction force applied to the target from the suction holes via the communication portions that are communicated with the suction openings.

According to the structure, since the transport body for transporting the target on the support surface of the support member is provided, the shape of the target is not limited to a long shape, and can be applied to, for example, a piece target. In addition, the transport body is equipped with the communication portions that are communicated with the suction holes of the support member, so that the target placed on the upper surface of the transport body can be surly absorbed on the transport body by applying a suction force to the target form the suction holes via the communication portions.

According to a second aspect of the invention, there is provided a recording apparatus including the target transport device according to the first aspect of the invention and a recording unit for performing a recording processing on the target supported on the support surface of the support member.

According to the structure, the similar effects as those of the target transport device can be obtained.

According to a third aspect of the invention, there is provided a target transport device including a first support member having a support surface capable of supporting a target that is transported toward a downstream side from an upstream side, suction openings of suction holes capable of generating a negative pressure when the suction holes are suctioned being formed on the support surface, a heater for heating the first support member, and a second support member for supporting the target and for heating the supported target at the upstream side or the downstream side of the first support member. Heat areas that are patterned as for a heat amount are provided in the second support member so as to correspond to uneven distribution of the suction openings of the first support member in a direction perpendicular to a transport direction of the target.

According to the structure, the temperature difference generated in the target can be restrained by patterning the heat area of the second support member such that a heat amount of the area of the second member corresponding to the high occupation area of the suction openings of the first support member becomes larger than the other part. Accordingly, occurrence of drying unevenness of the target can be restrained while absorbing the target to assure flatness thereof in the process of transporting the target.

### BRIEF DESCRIPTION OF THE DRAWINGS

The invention will be described with reference to the accompanying drawings, wherein like numbers reference like elements.

FIG. 1 is a front view schematically showing a printer of an embodiment.

FIG. 2 is a development front view showing a belt transport device of the printer.

FIG. 3 is a cross sectional view taken along the line III-III of FIG. 2.

### DESCRIPTION OF EXEMPLARY EMBODIMENTS

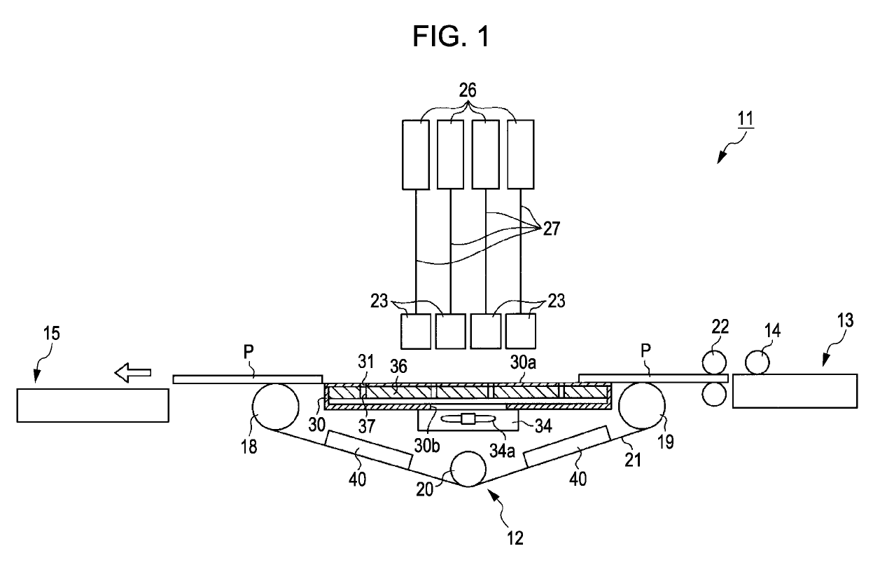

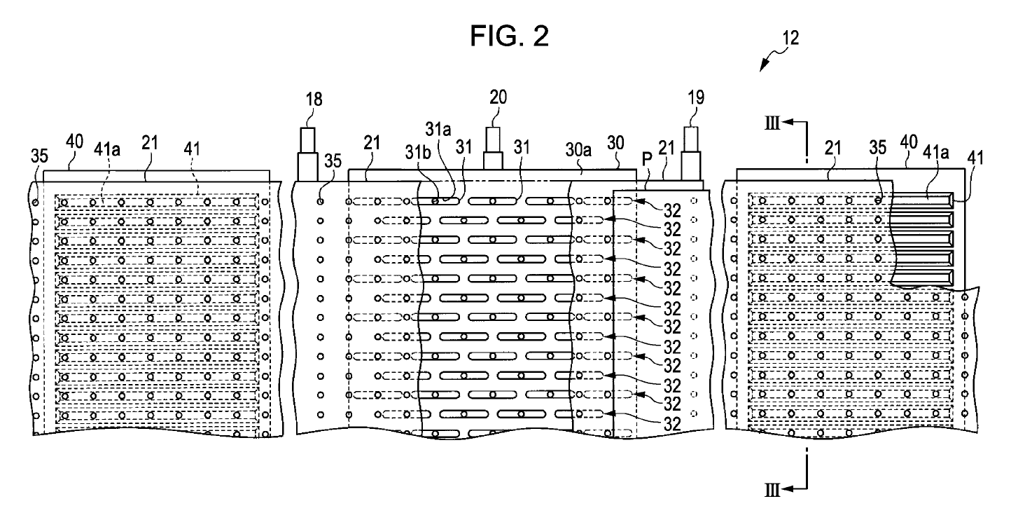

Hereinafter, an embodiment in which a recording apparatus of the invention is provided by an ink jet type printer will be described with reference to FIGS. 1 and 2.

As shown in FIG. 1, an ink jet type printer 11 as a recording apparatus is equipped with a belt transport device 12 as a target transport device for transporting a recording paper P as a target. The belt transport device 12 is equipped with a driving roller 18 capable of being rotary driven by a driving source not shown, the driving roller 18 being provided at a down stream side in a paper transport direction, a driven roller 19 capable of being rotated, the driven roller 19 being provided at an upstream side in the paper transport direction, and a tension roller 20 capable of being rotated, the tension roller 20 being provided at a slightly lower side of approximately the center position between the driving roller 18 and the driven roller 19.

A transport belt 21 as an endless transport body is wrapped around each roller 18, 19, 20 to surround each roller 18, 19, 20. The transport belt 21 is circumferentially moved along the outside of each roller 18, 19, 20 by rotary driving the driving roller 18 in an anti clockwise direction in FIG. 1.

A paper feed unit 13 is provided at the upstream side (right side in FIGS. 1 and 2) of the belt transport device 12, and gate rollers 22 are provided between the paper feed unit 13 and the belt transport device 12. The recording paper P laminated in the paper feed unit 13 is to be fed to the belt transport device 12 via the gate rollers 22 one by one by a paper feed roller 14. On the other hand, a paper discharge unit 15 to which the paper P after printed is discharged from on the transport belt 21 is provided at the downstream side (left side in FIGS. 1 and 2) of the belt transport device 12. Accordingly, the paper P after printed is sequentially laminated in the discharge unit 15.

A platen 30 as a support member having a rectangular box shape is provided at a position between the driving roller 18 and the driven roller 19 inside the transport belt 21 so that a support surface 30a which is the upper surface is made contact with the transport belt 21. Accordingly, the transport belt 21 slides on the support surface 30a when the recording paper P placed on the transport belt 21 is transported toward the downstream side from the upper stream side.

Further, an auxiliary platen 40 having a rectangular plate shape as temperature adjusting means is provided at each of a position between the driven roller 19 and the tension roller 20 and a position between the driving roller 18 and the tension roller 20 in such a way that each of the lower surface side of the auxiliary platens 40 is made contact with the transport belt 21. Note that a heater (omitted in FIG. 1) is embedded in each auxiliary platen 40, and heat from the heater is to be transmitted to the transport belt 21 from the lower surface side of the auxiliary platen 40.

A plurality of recording heads 23 (four in the embodiment) having a long shape of a line head system as recording means are disposed to oppose the support surface 30a of the platen 30 above the platen 30. Each recording head 23 extends in parallel to the width direction (direction perpendicular to the transport direction of the recording paper P) of the transport belt 21, and disposed in parallel along the transport direction of the recording paper P. Each recording head 23 is connected to an ink cartridge 26 via an ink supply tube 27, and ink whose type (color) is different to each other is to be supplied to each recording head 23 from the corresponding ink cartridge 26.

A number of nozzles (omitted in FIG. 1) for ejecting the ink supplied from the ink cartridge 26 are provided at the lower surface of each recording head 23. Printing (recording processing) of the recording paper P is to be performed by sequentially ejecting ink on the recording paper P from each nozzle at a timing matched with a transport speed of the recording paper P that is transported by the transport belt 21.

Next, a structure of the platen 30 will be described in detail.

A number of suction holes 31 that penetrate the platen 30 in an up and down direction (thickness direction of the platen 30) are formed in the platen 30 as shown in FIGS. 1 and 2. Each suction hole 31 is constituted by a long groove portion 31a that constitutes a suction opening on the support surface 30a of the platen 30 and that is long in the transport direction of the recording paper P, and a small hole portion 31b that is continuously formed on an inner bottom surface of the long groove portion 31a. The small hole portion 31b is positioned at the center of the long groove portion 31a in the longitudinal direction. The width of the long groove portion 31a and the width of the small hole portion 31b are set to be approximately the same in the direction perpendicular to the transport direction of the recording paper P.

A plurality of suction holes 31 are aligned along the left and right direction (transport direction) with the same interval to constitute a suction hole row (suction opening row) 32, and a plurality of suction hole rows 32 are aligned in parallel to each other with the same interval in the front and back direction (direction perpendicular to the transport direction). In this case, the suction holes 31 are aligned in a staggered manner as a whole.

The area corresponding to each suction hole row 32 on the support surface 30a of the platen 30 is a high occupation area in which the occupation ratio of the long groove portions 31a (suction opening) of the suction holes 31 is high, whereas the area sandwiched by the suction hole rows 32 is a low occupation area in which the occupation ratio of the long groove portions 31a (suction opening) of the suction holes 31 is relatively low. That is, the long groove portions 31 (suction openings) of the suction holes 31 are unevenly distributed on the support surface 30a of the platen 30. Note that, there is no long groove portion 31a (suction opening) of the suction hole 31 in the low occupation area at all, so that the occupation ratio of the long groove portions 31a (suction openings) of the suction holes 31 in the low occupation area is zero in the embodiment.

An opening 30b by which the inside and the outside of the platen 30 are communicated is provided at the center of the lower surface of the platen 30, and an attraction fan 34 having a suction fan 34a is provided to seal the opening 30b. A heater 36 as heating means having a rectangular plate shape corresponding to the support surface 30a in plan view is provided in the platen 30 so as to make contact with the upper surface inside the platen 30 from the lower side. The heater 36 generates heat by supplying a current from a power source not shown, and approximately uniformly heats the entire of the support surface 30a of the platen 30. Accordingly, the heat from the heater 36 is to be transmitted to the recording paper P via the platen 30 and the transport belt 21.

A through hole 37 that penetrates the heater 36 in the up and down direction is formed in the heater 36 at each of the positions corresponding to suction holes 31 (small hole portions 31b) of the platen 30. Further, communication holes 35 as communication portions capable of communicating with each suction hole 31 are formed in the transport belt 21 to penetrate the transport belt 21 up and down at the positions corresponding to each suction hole 31 (long groove portion 31a) opened on the support surface 31a of the platen 30.

When the suction fan 34a is rotated by driving the attraction fan 34, the inside of the platen 30 is suctioned via the opening 30b to generate a negative pressure inside each through hole 37 and inside each suction hole 31. Herewith, the recording paper P is suctioned at the platen 30 side by the generation of the negative pressure. That is, the suction force from each suction hole 31 acts on the recording paper P placed on the transport belt 21 via the communication holes 35 to absorb the recording paper P on the transport belt 21.

Next, a structure of the auxiliary platen 40 will be described in detail.

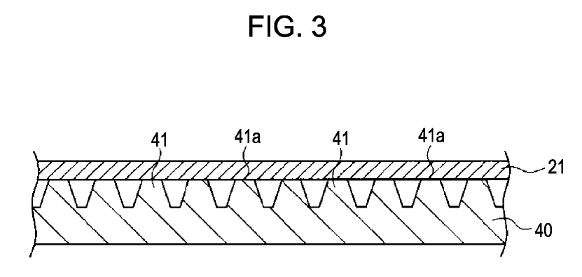

As shown in FIGS. 2 and 3, a plurality of protrusions 41 each having an approximately isosceles trapezoid shape in cross sectional view extending along the transport direction of the paper P are provided on the surface of the auxiliary platen 40 at the transport belt 21 side. The upper surface of each protrusion 41 is a sliding contact surface 41a that comes into slide contact with the surface opposite to the side at which the recording paper P is placed of the transport belt 21. The protrusions 41 are arranged in parallel to each other with the same interval along the direction perpendicular to the transport direction of the recording paper P. Each protrusion 41 corresponds to each suction hole row 32 on the support surface 30a of the platen 30 in the circumferential moving direction of the transport belt 21.

That is, each protrusion 41 of the auxiliary platen 40 is provided on an extension line extending from each suction hole row 32 on the support surface 30a of the platen 30 along the circumferential moving direction of the transport belt 21. Accordingly, when the recording paper P is transported by the transport belt 21, the area of the transport belt 21 that slides on the sliding contact surface 41a of each protrusion 41 of the auxiliary platen 40 is to slide on the high occupation area (area corresponding to each suction hole row 32 of the support surface 30a) on the support surface 30a of the platen 30.

Note that each area between protrusions 41 (sliding contact surfaces 41a) of the auxiliary platen 40 correspond to each of the low occupation area on the support surface 30a (each area between the suction hole rows 32 on the support surface 30a) of the platen 30 in the circumferential moving direction of the transport belt 21.

Next, an operation of the ink jet type printer 11 constituted as described above will be described.

When printing is performed on the recording paper P, the driving roller 18 is driven to start transport of the recording paper P by the transport belt 21 in the state where the attraction fan 34 is driven and a current is supplied to the heater 36. Then, when the recording paper P is transported on the platen 30 by the transport belt 21, a suction force of the attraction fan 34 is acted on the recording paper P disposed on the transport belt 21 via the opening 30b, each through hole 37, each suction hole 31, and each communication hole 35, and the recording paper P is absorbed on the transport belt 21.

At this time, since heat from the heater 36 is uniformly applied to the support surface 30a of the platen 30, the heat form the heater 36 is transmitted to the recording paper P from the support surface 30a via the transport belt 21. Then, the ink ejected from each nozzle (omitted in FIG. 1) of each recording head 23 is adhered on the recording paper P heated by the heat from the heater 36 to perform printing on the recording paper P.

Herein, in the high occupation area on the support surface 30a of the platen 30, the support surface 30a and the transport belt 21 are hardly made contact with each other, so that the heat from the support surface 30a is hardly transmitted to the transport belt 21. In addition, each suction hole 31 suctions the ambient air, so that the transport belt 21 is reversely cooled down in the high occupation area on the support surface 30a by the air flow. On the other hand, in the low occupation area on the support surface 30a, the support surface 30a and the transport belt 21 are fully made contact with each other, so that the transport belt 21 is fully heated.

As a result, in the process that the transport belt 21 slides on the support surface 30a of the platen 30, the temperature of the area of the transport belt 21 that slides on the support surface 30a in the low occupation area becomes higher than the temperature of the area of the transport belt 20 that slides on the support surface 30a in the high occupation area. Since a temperature difference is generated in the transport belt 21, a temperature difference is also generated in the recording paper P absorbed on the transport belt 21.

In this regard, in the embodiment, the transport belt 21 is heated only in the area in which the transport belt 21 slides in the high occupation area of the support surface 30a of the platen 30 in a process of sliding on the sliding contact faces 41a of the two auxiliary platens 40 in a step before sliding on the support surface 30a of the platen 30. That is, in the step before sliding on the support surface 30a of the platen 30, the temperature of the transport belt 21 is adjusted so that the temperature of the area of the transport belt 21 that slides on the support surface 30a of the platen 30 in the high occupation area becomes higher than the temperature of the area of the transport belt 21 that slides on the support surface 30a of the platen 30 in the low occupation area.

Since the transport belt 21 receives heat from the support surface 30a of the platen 30 in the process of sliding on the support surface 30a of the platen 30, the temperature difference provided by the two auxiliary platens 40 becomes small, and the temperature of the transport belt 21 is approximately uniformed. That is, the temperature difference of the transport belt 21 generated by sliding on the two auxiliary platens 40 and the temperature difference of the transport belt 21 generated by sliding on the support surface 30a of the platen 30 are canceled.

As a result, the recording paper P is approximately uniformly heated on the support surface 30a of the platen 30 over the entire area by receiving heat from the transport belt 21 that is approximately uniformly heated. As a result, the ink adhered on the recording paper P by printing is approximately uniformly heated to be dried, so that occurrence of smudge or aggregation of ink on the recording paper P is restrained. Note that the recording paper P after printing is finished is discharged in the discharge paper unit 15 from on the transport belt 21.

According to the embodiment described in detail, effects described below can be obtained.

(1) In general, a contact time of the area of the transport belt 21 that passes through the low occupation ratio area of the support surface 30a becomes longer than that of the area that passes through the high occupation ratio area of the support surface 30a in the process of sliding on the support surface 30a of the platen 30. That is, since a heat amount received from the support surface 30a in the area of the transport belt 21 that passes through the low occupation area becomes larger than a heat amount received from the support surface 30a in the area of the transport belt 21 that passes through the high occupation area, a temperature difference is generated on the support surface 30a. Accordingly, heat is transmitted to the recording paper P placed on the transport belt 21 from the transport belt 21 in which a temperature difference is generated, which generates a temperature difference also in the recording paper P similarly to the transport belt 21. When printing is performed in the state where the temperature difference is generated in the recording paper P, drying unevenness generates in the recording paper P on which ink is adhered to invite deterioration of print quality.

In this regard, in the embodiment, the two auxiliary platens 40 adjust the temperature of the transport belt 21 such that the temperature of the area of the transport belt 21 corresponding to the low occupation ratio area of the support surface 30a becomes lower than the temperature of the area of the transport belt 21 corresponding to the high occupation ratio area of the support surface 30a, so that the temperature difference of the transport belt 21 generated on the recording paper P can be reduced. Accordingly, since the temperature difference generated in the recording paper P is also reduced, the recording paper P can be approximately uniformly heated. As a result, in the transport process of the recording paper P, the recording paper P on which ink is adhered can be approximately uniformly heated to be dried while absorbing the recording paper P on the transport belt 21 to assure flatness thereof. In this manner, since occurrence of drying unevenness of the recording paper P on which ink is adhered can be restrained, print quality of the recording paper P can be improved.

(2) Since the two auxiliary platens 40 adjust the temperature of the transport belt 21 in the step before the recording paper P is transported on the support surface 30a of the platen 30 by the transport belt 21, the temperature of the transport belt 21 can be approximately uniformed on the support surface 30a with rapidly and the temperature of the recording paper P can be approximately uniformed with rapidly when heat from the support surface 30a is received by the transport belt 21 whose temperature is adjusted. Accordingly, when print is performed, the recording paper P on which ink is adhered can be approximately uniformly dried without fail.

Note that the embodiment may be modified as described below.

Any heating means except the heater may be employed as heating means for heating the two auxiliary platens 40. For example, a channel in which fluid can be flowed may be formed in each of the two auxiliary platens 40 to heat the both auxiliary platens 40 by supplying a hot fluid (for example, hot water or hot air) in the channels.

Any one of the two auxiliary platens 40 may be eliminated.

Each protrusion 41 of the auxiliary platen 40 may be disposed so as to correspond to each of the low occupation areas (each area between the suction hole rows 32) on the support surface 30a of the platen 30 in the circumferential moving direction of the transport belt 21, and the auxiliary platen 40 may be cooled by cooling means.

The transport belt 21 may be eliminated. In this case, a long roll paper is used as a target instead of the recording paper P. Then, the roll paper is sent from the right side (upstream side) of the belt transport device 12 in FIG. 1, and after printing is finished on the platen 30 (first support member), the roll paper 30 is rolled up at the left side (downstream side) of the belt transport device 12 in FIG. 1. In this case, a temperature difference may be applied to the roll paper by an auxiliary platen 40 (second support member) at the right side (downstream side) position than the transport belt 12 in FIG. 1. Alternatively, a temperature difference of the roll paper generated in the process when the roll paper passes through on the support surface 30a of the platen 30 may be restrained by providing the auxiliary platen 40 at the left side (downstream side) position than the belt transport device 12 in FIG. 1. In this case, the sliding contact surface 41a of each protrusion 41 of the auxiliary platen 40 constitutes a heat area that is patterned as for a heat amount so as to correspond to the uneven distribution of the long groove portion 31a of each suction hole 31 of the support surface 30a of the platen 30 in the direction perpendicular to the transport direction of the roll paper.

In the embodiment, the recording apparatus is not limited to the ink jet type printer 11. For example, the recording apparatus may be a printer having another print system such as, for example, a thermal transfer printer, a TA (thermo autochrome) printer, a laser printer, or the like.

What is claimed is:

1. A target transport device comprising:
a support member having a support surface capable of supporting a target that is transported toward a downstream side from an upstream side, suction openings of suction holes capable of generating a negative pressure when the suction holes are suctioned being formed on the support surface;
a heater for heating the support member; and
a temperature adjusting unit for adjusting a temperature of the target such that a temperature difference generated in the target due to uneven distribution of the suction openings that relatively become a low temperature in the support member when heat from the heater is applied to the target via the support surface of the support member is restrained.

2. The target transport device according to claim 1, wherein
the temperature adjusting unit adjusts the temperature of the target in a step before the target is transported on the support surface of the support member.

3. The target transport device according to claim 1, wherein
the temperature adjusting unit adjusts the temperature of the target such that a temperature of an area of the target corresponding to a low occupation area on the support surface in which an occupation ratio of the suction openings is relatively low becomes lower than a temperature of an area of the target corresponding to a high occupation area on the support surface in which the occupation ratio of the suction openings is relatively high.

4. The target transport device according to claim 1, further comprising:
a transport body for placing the target, the transport body being interposed between the target and the support member and being equipped with communication portions capable of communicating with the suction openings, wherein
the target is absorbed on the transport body by a suction force applied to the target from the suction holes via the communication portions that are communicated with the suction openings.

5. A recording apparatus comprising:
the target transport device according to claim 1; and
a recording unit for performing a recording processing on the target supported on the support surface of the support member.

6. A target transport device comprising:
a first support member having a support surface capable of supporting a target that is transported toward a downstream side from an upstream side, suction openings of suction holes capable of generating a negative pressure when the suction holes are suctioned being formed on the support surface;
a heater for heating the first support member; and
a second support member for supporting the target and for heating the supported target at the upstream side or the downstream side of the first support member, wherein
heat areas that are patterned as for a heat amount are provided in the second support member so as to correspond to uneven distribution of the suction openings of the first support member in a direction perpendicular to a transport direction of the target.
